(19) United States
(12) Patent Application Publication
(10) Pub. No.: US 2011/0006607 A1
(43) Pub. Date: Jan. 13, 2011

(54) HYBRID POWER SUPPLY APPARATUS FOR DATA CENTER

(75) Inventors: Won-Ok KWON, Daejeon (KR); Seong Woon KIM, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/638,426

(22) Filed: Dec. 15, 2009

(30) Foreign Application Priority Data
Jul. 10, 2009 (KR) 10-2009-0062884

(51) Int. Cl. H02J 9/00

(52) U.S. Cl. 307/66

(57) ABSTRACT

A hybrid power supply apparatus for data center includes: one or more power sources; and an uninterruptible rack level power supply unit supplied with an Alternating Current (AC) power from said one or more power sources, and configured to supply Direct Current (DC) power to a rack, the power supply unit supplying the DC power to the rack without interruption when supply of the power from said one or more power sources is stopped. The apparatus further includes a node provided in the rack and supplied with the DC power from the uninterruptible rack level power supply unit.

### CROSS-REFERENCE(S) TO RELATED APPLICATION

The present invention claims priority of Korean Patent Application No. 10-2009-0062884, filed on Jul. 10, 2009, which is incorporated herein by reference.

### FIELD OF THE INVENTION

The present invention relates to power supply technology for a data center, and, more particularly, to a hybrid power supply apparatus for data center, which is suitable for supplying Direct Current (DC) power at a rack level or node level while maintaining compatibility with a power equipment of an Alternating Current (AC) data center.

### BACKGROUND OF THE INVENTION

Currently, a large number of data centers are being operated by internet portal service providers and the like all over the world. Therefore, a technology for efficiently managing a power of each data center has been studied from various viewpoints.

Such a data center, in particular, an Alternating Current (AC) data center needs to be considered in both energy efficiency of centralized Uninterruptible Power Supply (UPS) architecture and energy loss attributable to multi-step energy conversion. Accordingly, in order to improve the energy efficiency of a data center, switching from an AC data center to a DC data center has been pursued.

However, since a DC data center is not compatible with the power equipment of the existing AC data center, several objectives to be attained, i.e., not only an addition of power equipment, but also a guarantee of safety in a high DC voltage and a definition of DC distribution standards, still remain when switching is made from an AC data center to a DC data center.

Therefore, an environment for a power system capable of maintaining compatibility with the existing AC data center while utilizing peculiar advantages of a DC data center is required.

### SUMMARY OF THE INVENTION

Therefore, the present invention provides a power supply technology which changes centralized Uninterruptible Power Supply (UPS) to rack level or node level (e.g., computer, server or the like) distribution architecture, thereby reducing installation costs and increasing energy efficiency.

In accordance with an aspect of the present invention, there is provided a hybrid power supply apparatus for data center including: one or more power sources; an uninterruptible rack level power supply unit supplied with an Alternating Current (AC) power from said one or more power sources, and configured to supply Direct Current (DC) power to a rack, the power supply unit supplying the DC power to the rack without interruption when supply of the power from said one or more power sources is stopped; and a node provided in the rack and supplied with the DC power from the uninterruptible rack level power supply unit.

In accordance with another aspect of the present invention, there is provided a hybrid power supply apparatus for data center including: one or more power sources; a rack level power supply unit supplied with a power from said one or more power sources and configured to supply Direct Current (DC) power to a rack; and a node provided in the rack and supplied with the DC power from the rack level power supply unit, the node supplying the DC power to the rack without interruption when supply of the DC power from said one or more power sources is stopped.

### BRIEF DESCRIPTION OF THE DRAWINGS

The above and other objects and features of the present invention will become apparent from the following description of preferred embodiments, given in conjunction with the accompanying drawings, in which:

FIG. 1 is a block diagram showing a configuration of a hybrid power supply apparatus for data center in accordance with an embodiment of the present invention;

FIG. 2 is a block diagram showing a configuration of a hybrid power supply apparatus for data center in accordance with another embodiment of the present invention;

FIG. 3 is a block diagram showing a detailed configuration of the uninterruptible node level power supply unit in FIG. 2; and

FIG. 4 is a timing diagram showing power control signals of a voltage monitoring unit.

### DETAILED DESCRIPTION OF THE EMBODIMENTS

Hereinafter, the embodiments of the present invention will be described in detail with reference to the accompanying drawings which form a part hereof.

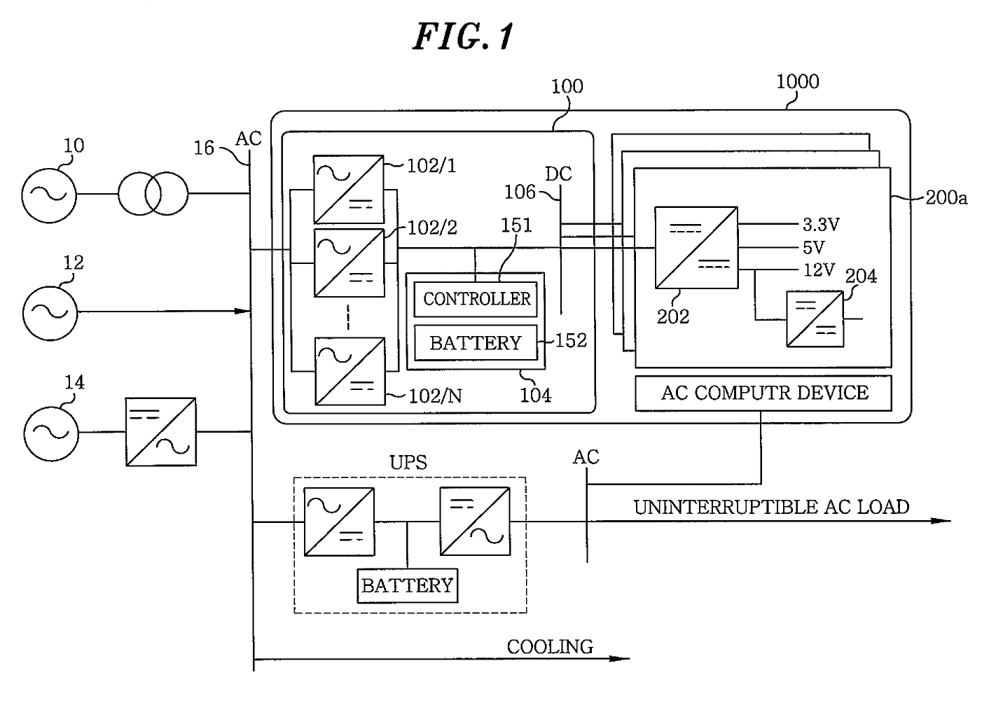

FIG. 1 is a block diagram showing a configuration of a hybrid power supply apparatus for data center, i.e., a rack level hybrid power supply apparatus for data center in accordance with an embodiment of the present invention. The hybrid power supply apparatus includes a first power source 10, a second power source 12, a third power source 14, an AC power line 16, and a rack 1000.

As shown in FIG. 1, the first power source 10, i.e., an AC power source, is for supplying an AC power (public grid) from a power station (not shown) to a data center through the AC power line 16. The supplied AC power is converted from a medium voltage to a low voltage and the low voltage is supplied to the data center. The AC power converted to the low voltage is applied to an AC switch (not shown) and is used as a power for a computer device or a cooling device.

The second power source 12, i.e., a diesel generator or the like, is for supplying an AC power to the data center when a power supply from the AC power source, i.e., the first power source 10, is suspended.

The third power source 14, i.e., solar light, a fuel cell or the like, functions as the additional power source (DC generator) for the AC power source, i.e., the first power source 10.

The power having passed through the AC switch is supplied to racks of respective computers by a Power Distribution Unit (PDU) (not shown) to be used as a cooling power for the racks. That is, this power structure is made by removing a UPS (Uninterruptible Power Supply) from a power transmission path of which power reaches a PDU and racks via the UPS in a conventional power structure for a conventional AC data center.

The rack 1000 is supplied with a power from the first power source 10, the second power source 12 and the third power source 14 through the AC power line 16, and includes an Uninterruptible Rack level Power Supply Unit (uRPSU) 100, and respective computer devices 200.

In this case, the uRPSU 100 is for supplying the power from the power source 10, 12 or 14 to the rack 1000 and includes rack level rectifiers 102-1 to 102-N, an uninterruptible power supply unit 104, and a DC power line 106.

The rack level rectifiers 102-1 to 102-N function to rectify the AC power input through the AC power line 16 into a DC power. Since at least two or more rack level rectifiers 102-1 to 102-N are provided to form a power structure, they can supply a DC power without interruption even if a failure occurs in one rectifier, e.g., a first rectifier 102/1.

The uninterruptible power supply unit 104 monitors the DC power rectified by the rack level rectifiers 102-1 to 102-N, and supplies a temporary power based on the results of the monitoring.

In detail, the uninterruptible power supply unit 104 includes a controller 151 for determining whether voltage step-down or a power failure has occurred in the input DC power and controlling operations related to charging and discharging depending on the results of the determination, and a battery 152 for supplying power to a load under the control of the controller 151 for the operations related to charging and discharging.

The DC power line 106 provides the DC power, supplied by the rack level rectifiers 102-1 to 102-N or the uninterruptible power supply unit 104 to each of the computer devices 200.

The computer device 200 is, e.g., a server included in a node and includes a DC/DC conversion unit 202 and a Voltage Regulator Module (VRM) 204.

The DC/DC conversion unit 202 functions to convert the input DC power into a voltage that can be used by the computer device 200, and, e.g., a PDB (Power Distribution Board) may be used as the DC/DC conversion unit 202.

Generally, since the computer device uses ATX (Advanced Technology Extended) power standards, the PDB converts the input DC power into a voltage of 12V, 5V, 3.3V, 5Vsb or −12V. However, since the PDB cannot be applied in a rack, devices that cannot use DC power are present in the rack. Representatives of these devices may be network equipment or large-capacity storage.

These devices need to be supplied with a power from the AC switch. However, since the devices also require the stabilization of power through the UPS, an AC UPS suitable for the capacity of the AC equipment of the computer device is installed, and thereafter the devices use AC power having passed through the AC UPS.

Next, a hybrid power supply method for a data center in accordance with the present embodiment, i.e., the operating process of the hybrid power supply apparatus for data center under a condition of a power failure or an abnormal power module, will be described with reference to FIG. 1.

First, when a power failure occurs in the AC power source, i.e., the first power source 10, from about several seconds to several minutes is required until the diesel generator, i.e., the second power source 12 may be operated.

In this case (before the second power source 12 is operated), the supply of a power to cooling devices or other AC loads which are not connected to an AC critical path, e.g., the AC power line 16, is interrupted. In contrast, devices which are connected to the AC critical path may be guaranteed to continuously operate because the AC UPS is activated.

Further, in the case of the uRPSU 100 provided in the rack 1000, a failure occurs in the input AC power, and thus the operation of the rectifiers is stopped and output DC power is decreased. In this case, the uninterruptible power supply unit 104 provided in each rack 1000 is operated, thus enabling the DC power to be reliably supplied to all computer devices which are supplied with DC power from the rack 1000.

Further, when the second power source 12 is operated, equipments connected to all AC switches switch their mode to normal operation mode. Then, when the AC power source, 10 is recovered, the diesel generator, i.e., the second power source 12, also stops its operation.

If a failure occurs in the rack level rectifiers 102-1 to 102-N of the uRPSU 100, the power supply apparatus can be safely operated by the rack-level uninterruptible power supply unit 104.

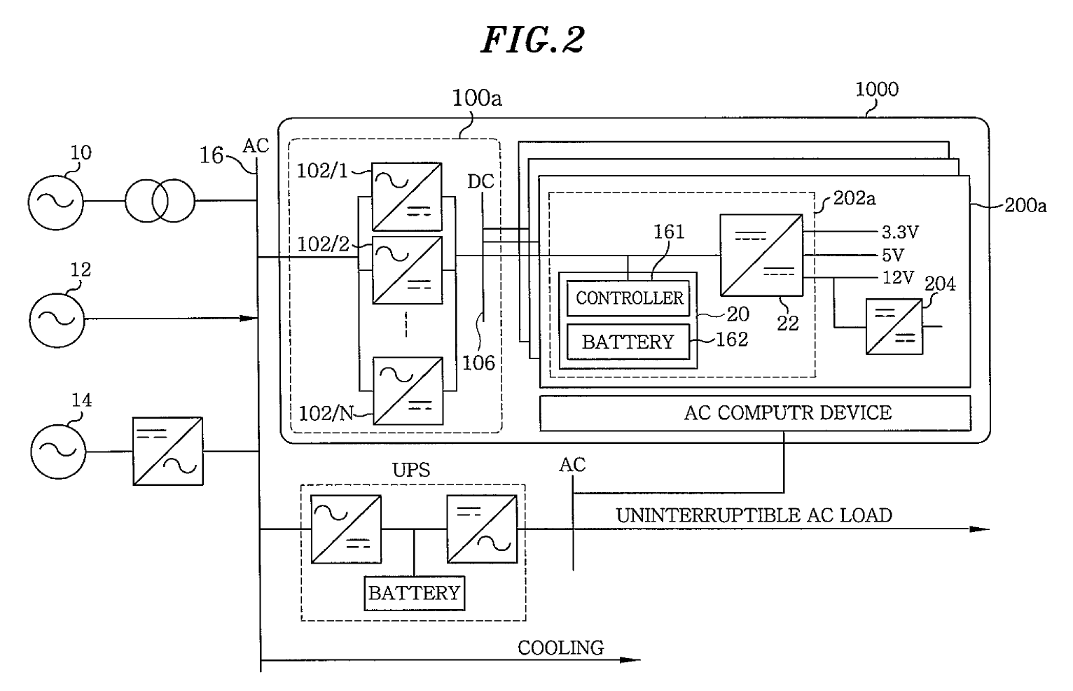

FIG. 2 is a block diagram showing a configuration of a hybrid power supply apparatus for data center in accordance with another embodiment of the present invention, i.e., a node level hybrid power supply apparatus for data center. The power supply apparatus includes a first power source 10, a second power source 12, a third power source 14, an AC power line 16 and a rack 1000.

In detail, FIG. 2 illustrates a power supply structure of the apparatus at an uninterruptible node (computer or server) level which is one step decreased compare to the power supply structure at the rack level in FIG. 1. A detailed description of components identical or similar to those of FIG. 1 will be omitted.

The hybrid power supply apparatus includes a rack 1000 having therein a rack level power supply unit 100a and an uninterruptible node level power supply unit 202a provided in each computer device 200a.

First, in the rack level power supply unit 100a includes rack level rectifiers 102-1 to 102-N for converting AC power input to the rack 1000 to DC voltage thereby outputting the DC voltage to each computer device.

Each computer device includes an uninterruptible node level power supply unit 202a in which a PDB (power distribution board), a battery 161 and a battery controller 162 are integrated.

The uninterruptible node level power supply unit 202a includes a DC/DC conversion unit 22 for converting DC power input from the rack level power supply unit 100a into a voltage used by the computer device 200a, and an uninterruptible power supply unit 20 having the battery 161 and the battery controller 162.

In the embodiment of FIG. 2, when a failure occurs, the computer device 200a connected to the rack level power supply unit 100a can be operated by the uninterruptible power supply unit 20 provided in each node. Accordingly, even before a diesel generator, i.e., the second power source 12, is operated after a failure has occurred, the uninterruptible node level power supply environment is implemented, and thus a DC power can be reliably supplied to the computer device 200a.

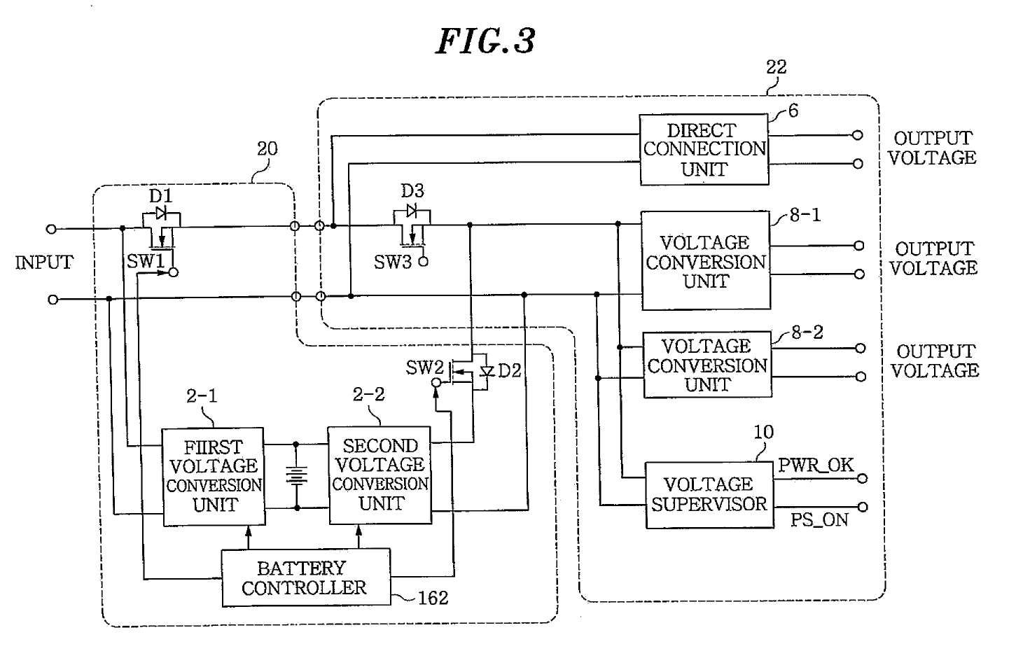

FIG. 3 is a diagram showing a detailed configuration of the uninterruptible node level power supply unit 202a shown in FIG. 2.

As shown in FIG. 3, the uninterruptible node level power supply unit 202a is divided into the uninterruptible power supply unit 20 and the DC/DC conversion unit 22.

The uninterruptible power supply unit 20 includes a battery (not shown), a battery controller 162 for controlling the battery, a first voltage conversion unit 2-1 for converting an input DC voltage into a voltage identical to that of the battery when the battery is charged and a second voltage conversion unit 2-2 for converting the input DC voltage into a voltage identical to that of the battery when the battery is discharged. The uninterruptible power supply unit 20 further includes diodes D1 and D2, an incoming switch SW1, and an input/output switch SW2. Here, the incoming switch SW1 and the input/output switch SW2 may be, e.g., Field Effect Transistor (FET) switches or the like.

The DC/DC conversion unit 22 includes a direct connection unit 6 for directly connecting input power to output power, voltage conversion units 8-1 and 8-2 for converting an input DC voltage into an output DC voltage used by the computer device 200a, a voltage supervisor 10 for supervising a status of a voltage and notifying a load of an abnormality of the voltage, a diode D3 and an FET switch SW3.

A detailed operation of the uninterruptible node level power supply unit 202a will be described below.

First, when an input DC power is applied to the uninterruptible node level power supply unit 202a, the applied DC power is transferred to the uninterruptible power supply unit 20.

The diode D1 and the incoming switch SW1 of the uninterruptible power supply unit 20 blocks reverse current (i.e., function of a diode), and performs on/off control of forward current by controlling a gate electrode of the FET. For example, when the gate electrode of the incoming switch SW1 is turned on, the incoming switch SW1 becomes on, whereas, when the gate electrode of the incoming switch SW1 is turned off, the incoming switch SW1 becomes off.

Here, when the input DC power is normally applied, the incoming switch SW1 of the uninterruptible power supply unit 20 is turned on, thereby supplying the DC power to the DC/DC conversion unit 22.

At this time, when the battery is not fully charged, charging of the battery is performed simultaneously with the supply of power. Since the voltage of the battery is not generally identical to the input voltage, the input DC power charges the battery via the first voltage conversion unit 2-1. When the battery is discharged, the input DC power is transferred to the DC/DC conversion unit 22 via the second voltage conversion unit 2-2.

Further, the battery controller 162 controls the gate of the input/output switch SW2. For example, when an abnormality occurs in the input voltage, the battery controller 162 supplies a normal battery output voltage to a load by turning on the input/output switch SW2.

In this case, the battery controller 162 may additionally include a computer interface. Such a computer interface can be connected using various communication protocols, e.g., RS232, I²C, and the Ethernet, and transmits the information of a battery of the node to a computer. In a computer, an agent capable of receiving the battery information is installed, and the status of the node battery can be monitored by the agent.

Voltage conversion of the DC power input to the DC/DC conversion unit 22 is classified into three types.

The first type is an output method by using the direct connection unit 6. That is, the input DC voltage is directly used as an output voltage. For example, when an input voltage is 12V, a voltage of 12V is used as the output voltage without converting the DC voltage.

The second type is an output method by using the voltage step-down conversion unit 8-1. That is, the input DC voltage is converted to be lower and the lower DC voltage is used as the output voltage. For example, when the input DC voltage is 12V, this is converted into an output voltage of 5V or 3.3V.

The third type is an output method by using the voltage step-up conversion unit 8-2. That is, an input voltage is converted to be higher and the higher voltage is used as the output voltage. For example, when an input voltage is 12V, it is converted into an output voltage of 24V.

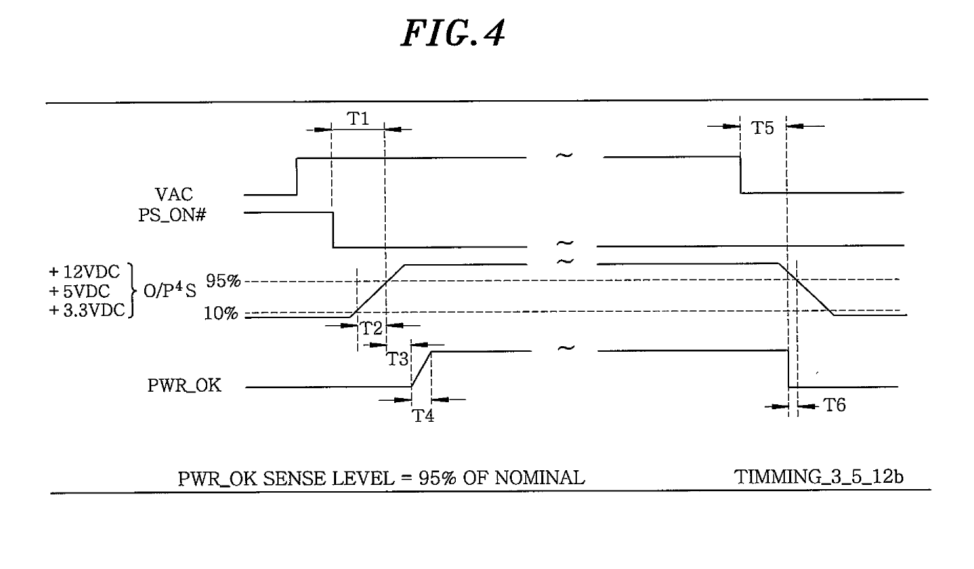

Further, the input DC voltage to be converted in the conversion units 8-1 and 8-2 is supervised by the voltage supervisor 10. That is, the voltage supervisor 10 generates a control signal such as a signal PS_ON or PWR_OK meeting ATX power standards, and notifies a load of an abnormality when the voltage is abnormal. The control signals PS_ON and PWR_OK meeting ATX power standards are shown in FIG. 4. The generation of the power control signals by the voltage supervisor 10 may be easily understood with reference to the timing diagram of the ATX power standards, as shown in FIG. 4.

As described above, the present embodiment provides power supply technology for changing a centralized UPS to a rack level or node level distribution structure, thus reducing installation costs and increasing energy efficiency, and also provides hybrid data center power structure capable of simultaneously solving the problems of an AC data center and a DC data center.

In accordance with the above embodiments, the present invention is advantageous in that, since DC power is supplied at the rack level without the power structure of a conventional AC data center being changed, and a UPS supplies temporary power at the rack level or node level, power efficiency and UPS efficiency may be improved (by about 10%), and N+1 power redundancy may be provided at the rack level. Accordingly, the present invention is advantageous in that an improvement in power efficiency is predicted to be about 20% or more, compared to an existing AC data center, and in that the installation of a large-scale UPS system is not required and there is a reduction in other related costs.

While the invention has been shown and described with respect to the preferred embodiments, it will be understood by those skilled in the art that various changes and modifications may be made without departing from the spirit and scope of the invention as defined in the following claims.

What is claimed is:

1. A hybrid power supply apparatus for data center, comprising:
one or more power sources;
an uninterruptible rack level power supply unit supplied with an Alternating Current (AC) power from said one or more power sources, and configured to supply Direct Current (DC) power to a rack, the power supply unit supplying the DC power to the rack without interruption when supply of the power from said one or more power sources is stopped; and
a node provided in the rack and supplied with the DC power from the uninterruptible rack level power supply unit.

2. The apparatus of claim 1, wherein the uninterruptible rack level power supply unit includes:
two or more rack level rectifiers for rectifying Alternating Current (AC) power from said one or more power sources into DC power;
an uninterruptible power supply unit for monitoring the DC power rectified by the rack level rectifiers to supply temporary DC power based on the monitored DC power; and
a DC power line for providing the DC power, rectified by the rack level rectifiers or the temporary DC power supplied by the uninterruptible power supply unit, to the node.

3. The hybrid power supply apparatus for data center of claim 2, wherein the uninterruptible power supply unit comprises:
a controller for controlling charging and discharging operations depending on results of monitoring of the DC power rectified by the rack level rectifiers; and
a battery for supplying power to the node under control of the controller for charging and discharging operations.

4. The hybrid power supply apparatus for data center of claim 3, wherein the controller determines whether voltage step-down or a power failure occurs on the DC power rectified by the rack level rectifiers, and controls charging and discharging operations depending on results of determination of the voltage step-down or the power failure.

5. The hybrid power supply apparatus for data center of claim 1, wherein the node comprises a DC/DC conversion unit for converting the DC power into a voltage to be used by the node.

6. The hybrid power supply apparatus for data center of claim 1, wherein the node includes a server.

7. The hybrid power supply apparatus for data center of claim 5, wherein the DC/DC conversion unit includes a Power Distribution Board (PDB).

8. A hybrid power supply apparatus for data center, comprising:
one or more power sources;
a rack level power supply unit supplied with a power from said one or more power sources and configured to supply Direct Current (DC) power to a rack; and
a node provided in the rack and supplied with the DC power from the rack level power supply unit, the node supplying the DC power to the rack without interruption when supply of the DC power from said one or more power sources is stopped.

9. The hybrid power supply apparatus for data center of claim 8, wherein the node includes an uninterruptible node level power supply unit configured such that, when a failure occurs in one power source among said one or more power sources, the DC power is supplied before another power source among said one or more power sources is operated.

10. The hybrid power supply apparatus for data center of claim 9, wherein the uninterruptible node level power supply unit includes:
an uninterruptible power supply unit for supplying the DC power to the node without interruption when normal DC power or abnormal DC power is input from said one power source among said one or more power sources; and
a DC/DC conversion unit for converting the DC power from the rack level power supply unit into output DC power to be used by the node.

11. The hybrid power supply apparatus for data center of claim 10, wherein the uninterruptible power supply unit comprises:
a battery;
a battery controller for controlling charging or discharging of the battery;
a first voltage conversion unit for converting an input DC voltage into a voltage identical to that of the battery when the battery controller controls charging of the battery; and
a second voltage conversion unit for converting the input DC voltage into a voltage identical to that of the battery when the battery controller controls discharging of the battery.

12. The hybrid power supply apparatus for data center of claim 11, wherein the battery controller is connected to a computer for monitoring status of the battery through an interface.

13. The hybrid power supply apparatus for data center of claim 12, wherein the interface connects the battery controller to the computer through a communication protocol.

14. The hybrid power supply apparatus for data center of claim 11, wherein the uninterruptible power supply unit includes:
an incoming switch turned on and configured to supply the DC power to the DC/DC conversion unit when the battery is fully charged; and
an input/output switch turned on and configured to supply the DC power converted by the second voltage conversion unit to the DC/DC conversion unit when the battery is not fully charged.

15. The hybrid power supply apparatus for data center of claim 14, wherein the incoming switch is a Field Effect Transistor (FET), the FET including a gate electrode which is turned on by the battery controller to turn on the FET when the DC power is normally supplied.

16. The hybrid power supply apparatus for data center of claim 14, wherein the input/output switch is an FET, the FET including a gate electrode which is turned on by the battery controller to turn on the FET when the DC power is abnormally supplied.

17. The hybrid power supply apparatus for data center of claim 10, wherein the DC/DC conversion unit includes:
a direct connection unit for directly connecting the DC power from the uninterruptible power supply unit to an output voltage;
a voltage conversion unit for converting the DC power into an output DC voltage to be used by the node; and
a voltage supervisor for supervising status of the DC power.

18. The hybrid power supply apparatus for data center of claim 17, wherein the voltage conversion unit comprises:
a voltage step-down conversion unit for stepping down a level of the DC power to a first preset level; and
a voltage step-up conversion unit for stepping up the level of the DC power to a second preset level.

19. The hybrid power supply apparatus for data center of claim 17, wherein the voltage supervisor generates a power control signal meeting Advanced Technology Extended (ATX) power standards, and transmits the power control signal to the node.

20. The hybrid power supply apparatus for data center of claim 8, wherein the node includes a server.
